(19) United States
(12) Patent Application Publication
(10) Pub. No.: US 2013/0167778 A1
(43) Pub. Date: Jul. 4, 2013

(54) Flying discs for canine catching having an anti-glare surface that prevents canine misses due to sunflash phenomenon

(71) Applicant: Jeffrey K. Perry, Cumming, GA (US)

(72) Inventor: Jeffrey K. Perry, Cumming, GA (US)

(21) Appl. No.: 13/339,917

(22) Filed: Dec. 29, 2011

(51) Int. Cl. A01K 29/00

(52) U.S. Cl. 119/707

(57) ABSTRACT

A flying disc for canines featuring a non-reflective, anti-glare surface that eliminates the possibility of misses caused by the reflection of sunlight from the glossy surface of a typical flying disc (sunflash), thereby allowing said disc to be more consistently caught by dogs. The anti-glare surface of the disc is obtained by incorporating into the surface, of an injection mold, a special frosted texture that is transferred to each disc produced in the mold. The frosted texture must contain enough fine detail to eliminate glare yet be non-abrasive in nature so as not to cause undue wear to canine teeth. The frosted surface texture may also be applied by processes including, but not limited to, in-mold decorating, decal, water-born graphic transfer, heat transfer, painting, acid bath, or other similar process.

### FIELD OF THE INVENTION

The invention relates particularly to discs intended to be thrown in the air by humans and caught by canines.

### BACKGROUND

Flying discs, such as the Frisbee® brand flying disc, have been around for years and are used by people of all ages. Flying discs are used for recreational purposes and are frequently utilized by enthusiasts in parks, yards, and even in the street. In addition to purely recreational use, flying discs are also used in sports for competitive purposes. For example, flying discs are used in a golf-like game, disc golf, as well as in a football-like game, ultimate.

The popularity of flying discs is not limited solely to humans and extends to canines as well. Many people enjoy tossing a flying disc to a canine and having the canine catch and retrieve the disc. Tossing a flying disc to a dog is therefore a recreational activity for both the person and the dog. Throwing discs to dogs has also developed into a competitive sport. For several decades, flying discs have been used in canine competitions typically referred to as canine disc or canine Frisbee® competitions.

Each year in the United States, and elsewhere in the world, competitions are held in more than 100 cities and participants compete in local, regional and international competition. The Skyhoundz® World Canine Disc Championship has been staged in the U.S. for the past decade and enthusiasts compete for a variety of world championship titles in long distance, distance/accuracy, freestyle, pairs freestyle, youth, and small dog divisions.

A typical flying disc used in canine competition has a rim formed along the perimeter of the disc that then transitions into the flight plate. While this description is accurate for many flying discs, flying discs have been made with various other shapes as evident by the discs described in U.S. Pat. No. 4,568,297 to Dunipace, U.S. Pat. No. 4,618,553 to Rodarte, U.S. Pat. No. 4,906,007 to Mitchell et al., D327,921 to Sobel, and D406,282 to Pinguelo. To date, all discs used in canine competition have been made with smooth glossy surfaces to aid in decorating said discs with logos via hot stamping, silk screening, or pad printing processes. However, smooth surfaces are highly reflective and when sunlight is reflected back from a shiny disc surface into the eyes of a pursuing canine, temporary blindness and missed catches can be the result. Regardless of the color in which a disc is manufactured, a disc with a glossy surface will still retain its highly reflective nature because of the “mirror finish” given to the injection mold in which all canine competition discs have historically been manufactured.

The phenomenon of canine misses caused by sunlight reflected from canine discs (hereinafter “sunflash”) was first observed by one of the inventors in the instant patent application, Jeff Perry, himself a world canine disc champion, canine disc author, and elite-level canine disc judge. During his many years of canine disc competition judging, Perry observed that canines often inexplicably miss throws even when said canines are in the perfect position to make catches of well-thrown discs. One day, while judging, Perry was in the perfect position to observe a sunflash that likely contributed to a missed catch by a canine. He realized then that sunflash-induced misses are probably not all that rare and may even cause a competing canine to miss several throws in a sequence until the temporary visual disturbance caused by the sunflash passes. He analogized what a canine experiences, to the experience of a flash camera going off in a human's face an instant before a task, such as catching a tossed ball, needs to be performed.

Trying this experiment on human subjects revealed that it might take as many as 10 seconds for a human, so blinded, to recover from the visual disturbance and see well enough to catch a tossed ball. Baseball players who glance at the sun, accidently, in the process of catching a high-fly ball, have been sun-blinded to the point of actually being hit by the same ball they were trying to catch. According to Perry, this problem has likely “flown under the radar” of canine disc competitors for years. After all, when a sunflash occurs, a competing canine is the only witness and dogs can't throw up a paw in front of their eyes or otherwise communicate the existence of the problem to their human teammates. Proving the theory was accomplished by creating conditions (disc angle, sun angle, throwing direction, canine approach angle, etc.) likely to result in sunflash misses and then making throws to canines using two groups of white discs, 1) a group with the standard glossy surface found on all canine discs and, 2) a group coated with a flat paint designed to neutralize glare. Repeating the tests with multiple canines confirmed that more misses occurred with glossy, more reflective, discs than with discs coated with a non-reflective, flat paint. Sunflashes were also observed by human witnesses positioned so as to observe canine catches at angles and positions conducive to verifying the phenomenon.

In competition, there is no practical way to mitigate the effect of sunflashes by adjusting throwing angles and technique. This is because throwing direction is often dictated by competition organizers as well as by wind conditions or field orientation at each competition venue. Since 1) the angle of a disc in flight cannot be precisely predicted or controlled by a thrower, and 2) wind conditions can cause a disc to pitch up or bank somewhat unpredictably in competition, and 3) because sun angle relative to a flying disc and a pursuing canine changes continuously during a typical day-long canine disc competition, and 4) given that calculating, on a throw-by-throw basis when a sunflash is likely to occur would be virtually impossible, a passive means of eliminating canine missed catches caused by sunflash would be beneficial.

Painting discs with an anti-glare paint or coating in post-production would neither be cost effective, safe, nor durable enough to withstand gnashing canine teeth. Additionally, because canines would be catching discs in their mouths, an anti-glare disc surface would have to be non-abrasive and non-toxic. The ideal solution would be to incorporate a very subtle non-abrasive frosted finish into the surface of a disc mold that would allow for the manufacture of a disc that would not reflect sunlight and thereby cause temporary visual disturbances in canines.

A need therefore exists for an improved canine flying disc, 1) that minimizes or eliminates the sunflash problem that causes canines to fail to catch a flying disc, 2) that minimizes or eliminates the sunflash problem without employing a finish that is abrasive to canine teeth, and 3) that has a surface texture that accomplishes the aforementioned objectives yet remains capable of being decorated with a manufacturer's logo via standard processes including hot stamping, silk screening, pad printing, in-mold decorating, etc.

### SUMMARY

The invention addresses the problems mentioned above by providing discs offering a specialized frosted texture that diffuses and inhibits sunlight reflection, and thereby eliminates canine-blinding sunflash. The discs according to the preferred embodiment of the invention feature a frosted texture with a depth of between 0.0004″ and 0.0006″, hereinafter referred to as X-Flash™ anti-glare finish. The X-Flash™ anti-glare finish was supplied by Mold-Tech of Lake City, Ga., and may be categorized as the Mold Tech MT 11000 finish. In a preferred embodiment, the X-Flash™ anti-glare finish is applied to a plastic injection mold so that the frosted texture is then imparted to any canine disc produced therefrom. The frosted surface texture may also be applied via a process referred to as in-mold decorating in which a thin polymer sheet, conforming to the exterior topside of an injection molded flying disc, is placed into the mold before plastic polymer is injected thereto. The thin polymer sheet then bonds to the plastic used during the injection molding process and becomes part of the flying disc. The frosted surface, regardless of how it is created, need only be applied to the top surface of the disc because sunflashes do not typically occur from sunlight reflected from the underside of a canine flying disc.

These discs should therefore present fewer problems during competition since canines will no longer miss catching discs by virtue of being temporarily blinded by sunlight reflected from disc surfaces. Further, because the X-Flash™ anti-glare finish is non-abrasive, discs made with the X-Flash™ finish will not cause greater than normal wear to canine teeth. The X-Flash™ finish is incorporated into a disc mold by a process that etches the frosted texture into the mold cavity that produces the flying discs or applies it by a process known as in-mold decorating. The X-Flash™ anti-glare finish may also be applied by processes including, but not limited, to, decal, water-born graphic transfer, heat transfer, painting, acid bath, or other similar process.

Discs made from a mold incorporating the X-Flash™ anti-glare finish also have additional features that present advantages over conventional discs. For example, given the proliferation of ultra-tough canine discs like Hyperflite's Jawz disc in competition, which are made from clear, high-temperature polymers like thermoplastic urethane (TPU), such discs, if made with the XFlash™ anti-glare finish, would be easier for canines to see. Here's why. Typically, clear resins like TPU require a substantial amount of pigment to achieve a solid color as opposed to a trans-lucent color. Therefore, most disc manufacturers, including Hyperflite, make virtually all of their ultra-tough discs in translucent colors. These translucent colors, while attractive, can make such discs more difficult for canines—with their limited color vision—to see in low-light conditions. Discs made with the X-Flash™ anti-glare finish, by virtue of their opaque characteristics, eliminate the need for increased amounts of colorant in order to achieve a solid-color appearance that is more visible to pursuing canines than a translucent disc would be under similar circumstances. Making an ultra-durable disc in a solid color, without the benefit of the X-Flash™ anti-glare finish, necessarily requires much more colorant. Injection molding colorants are often very expensive such that disc manufacturers merely use enough pigment to color a disc but not enough to create a solid color that is more visible to canines. Since translucent discs of certain colors, especially in low light conditions, can be exceptionally hard for canines to see, it stands to reason that the X-Flash™ anti-glare finish, which gives discs a more opaque appearance without requiring the use of more expensive colorant, would be highly desirable. Further, since colorant typically does not share the same properties, namely strength and flexibility, as the base resin used to make ultra-tough canine discs, adding copious amounts of colorant, to achieve a solid-color appearance, tends to make the finished product less durable for canine use. Less colorant therefore, equals more strength at a lower cost.

Finally, an added benefit to the X-Flash™ anti-glare finish occurs in the manufacturing process. During manufacturing, discs produced from highly-polished molds tend to “hang,” or get stuck, in mold cavities, whereas tools with the X-Flash™ anti-glare finish release much easier. Parts that hang in injection molds often become warped when a human operator has to manually remove the hung parts from mold cavities. Warped parts have to be rejected which consequently increases manufacturing costs. When a disc fails to eject automatically from a mold cavity, the natural part cycle time is also interrupted, necessitating the intervention of a human operator and that also increases costs. Discs with the X-Flash™ anti-glare finish are much less likely to hang because the frosted texture does not allow a disc to stick as readily to a mold cavity.

Finally, it should be understood that the specific description of the X-Flash™ anti-glare finish provided hereinabove, although ideal, is only exemplary and discs made with an anti-glare finish can accomplish a satisfactory result with greater or lesser levels of the frosted texture. In other words, the extent of the frosted finish can vary from the preferred embodiment and still achieve an acceptable result.

### BRIEF DESCRIPTION OF DRAWINGS

The accompanying drawings, which are incorporated in and form a part of the specification, illustrate preferred embodiments of the present invention and, together with the description, disclose the principles of the invention. In the drawings:

FIG. 1(A) is a perspective view of a disc depicting the preferred embodiment of the invention;

FIG. 1(B) is a top view of the disc;

FIG. 1(C) is a cross-sectional side view of the disc; and

FIG. 2 is a partial enlarged view of the disc showing shaded areas where the X-Flash anti-glare finish is applied.

FIG. 3 is a view of a canine disc reflecting sunlight into the eyes of a pursuing canine.

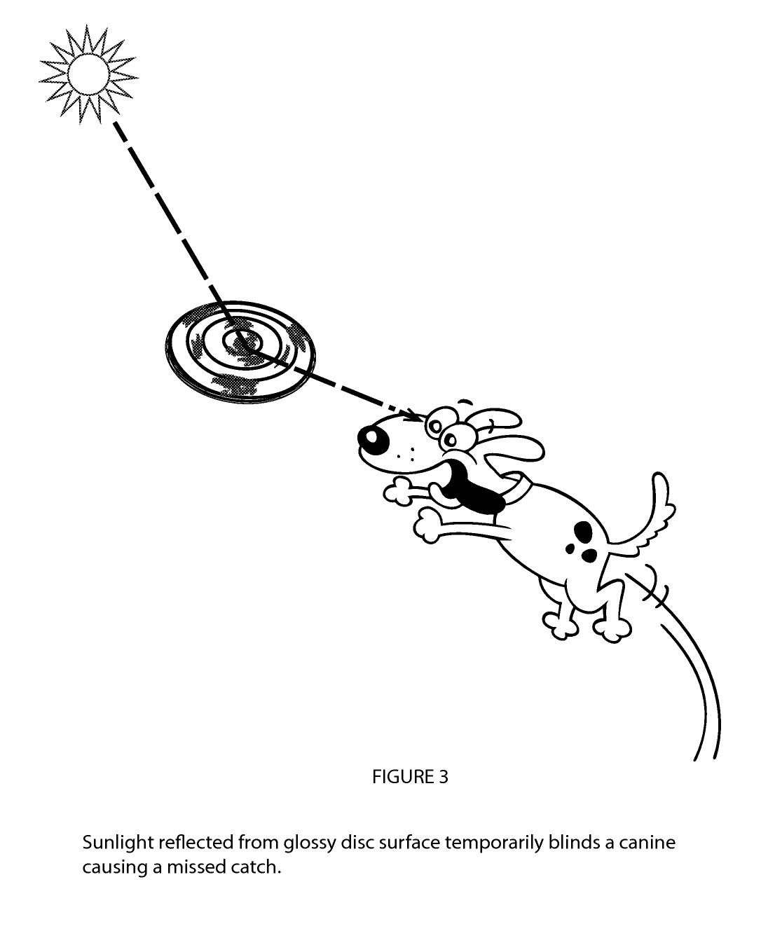

FIG. 4 is a view of a disc featuring the X-Flash anti-glare finish diffusing and scattering sunlight, thereby enabling a canine to catch the disc without being blinded by a sunflash.

### DETAILED DESCRIPTION

Reference will now be made in detail to preferred embodiments of the invention, non-limiting examples of which are illustrated in the accompanying drawings.

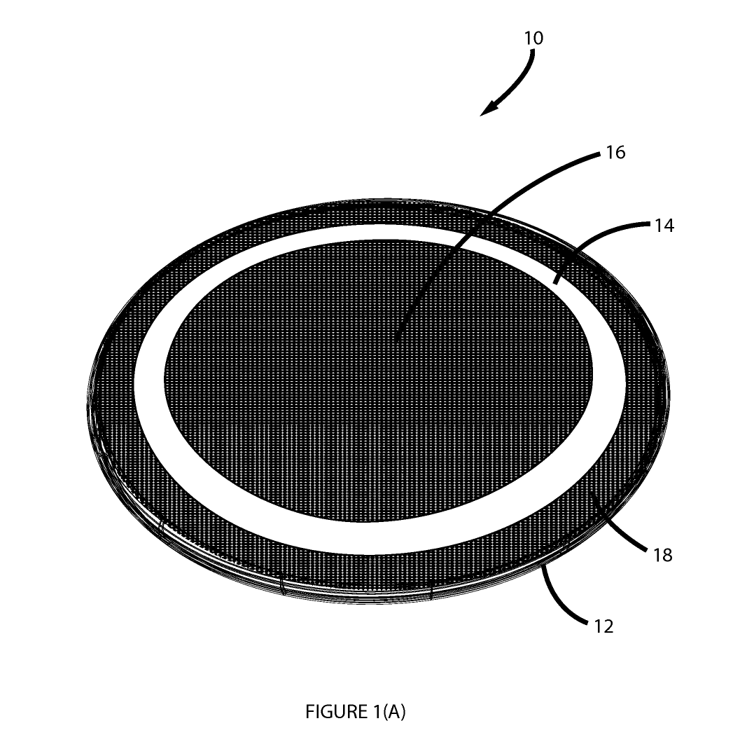

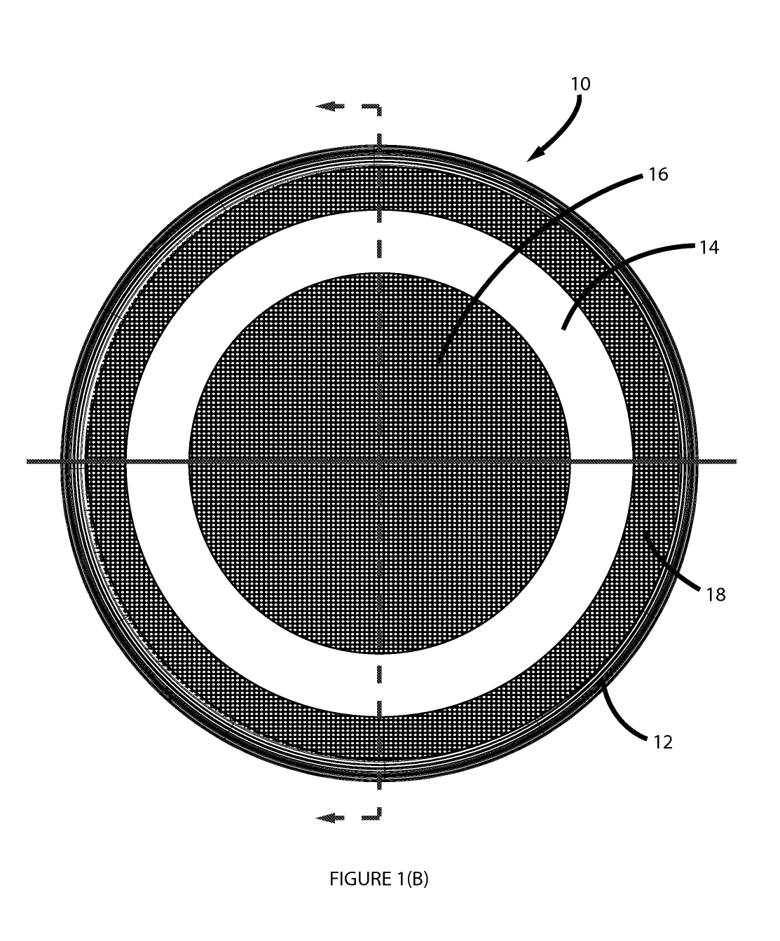

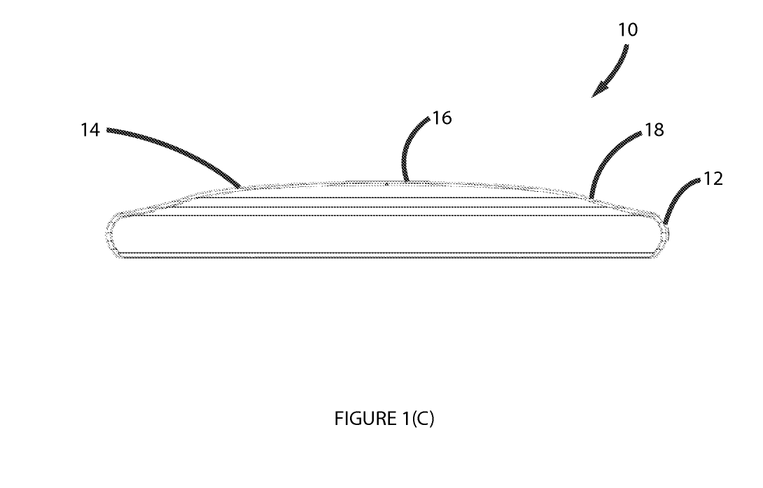

A flying disc 10 according to a preferred embodiment of the invention is shown in FIGS. 1(A) to 1(C). The flying disc 10 is comprised of a rim 12, a flight plate 16, and a transition area 14 between the rim 12 and flight plate 16. A gripping surface 18 is formed in the transition area 14 on the top of the flying disc.

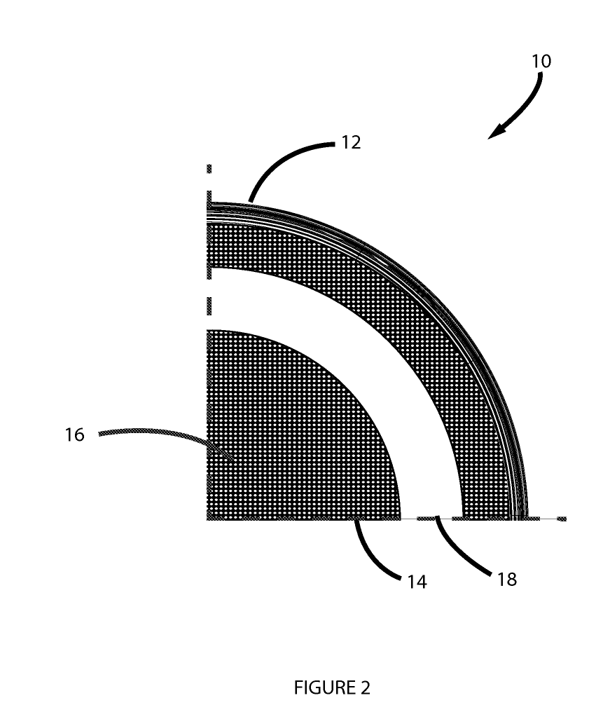

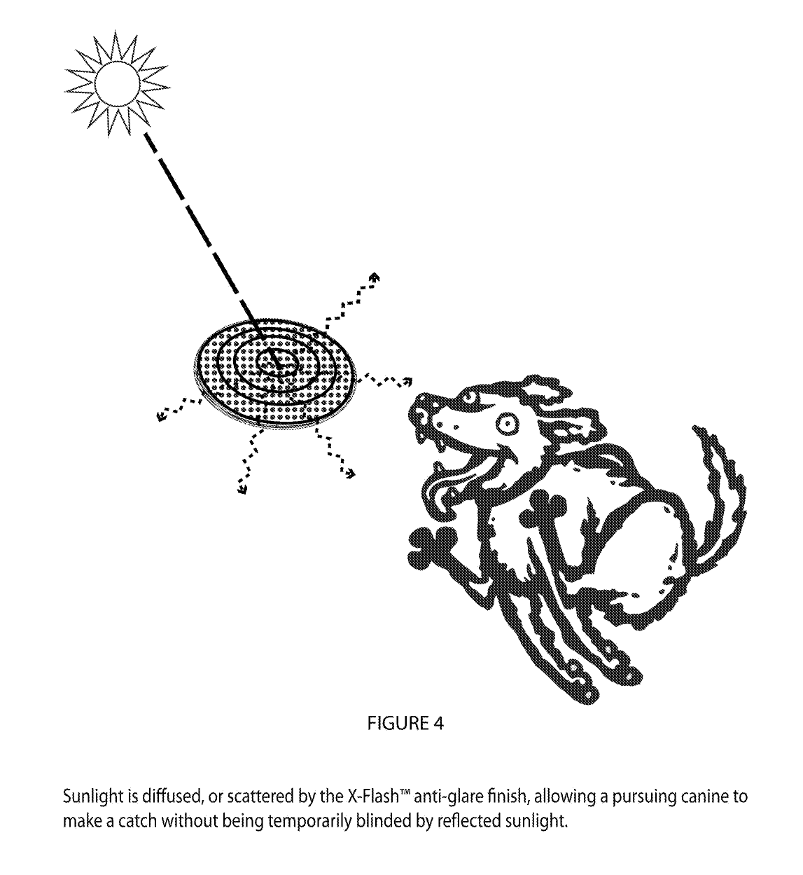

As best seen in FIGS. 1(A), 1(B), 1(C), FIG. 2, and FIG. 4, the flight plate, transition area and rim of the disc have the X-Flash anti-glare finish, relative to other parts of the flying disc 10, not including the grip surface, which have a typical smooth or polished finish.

In the preferred embodiment, a canine disc with the X-Flash anti-glare finish has a frosted texture with a depth of between 0.0004″ and 0.0006″, hereinafter referred to as X-Flash™ anti-glare finish 1(A), 1(B), 1(C), 2, and 4. The X-Flash™ anti-glare finish was supplied by Mold-Tech of Lake City, Ga., and is referred to as the Mold Tech MT 11000 finish. A typical canine disc, in contrast, has a mirror or highly-polished finish. It should be understood that the anti-reflective X-Flash™ finish shown in FIGS. 1(A), 1(B), 1(C), 2, and 4 is just one example and that other lesser or greater level of the frosted finish may be used to achieve varying levels of the X-Flash™ anti-glare effect.

The foregoing description of the preferred embodiments of the invention has been presented only for the purpose of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments with various modifications as are suited to the particular use contemplated.

What we claim:

1. A flying disc adapted to be thrown by humans and caught by canines, including: a. a rim; b. a flight plate; c. a transition area located between the flight plate and the rim; d. a top side; e. a bottom side; f. a continuous (with the exception of grip surfaces) frosted, non-abrasive texture located on the disc d. topside that is anti-reflective so as to eliminate canine misses caused by sunlight reflected from disc surfaces (sunflashes). The aforementioned frosted texture is non-abrasive to canine teeth and smooth enough to be decorated with customized logos using traditional processes such as hot stamping, silk screening, and pad printing. The frosted, non-abrasive, anti-glare texture may also be applied by processes including, but not limited to, in-mold decorating, decal, water-born graphic transfer, heat transfer, painting, acid bath, or other similar process.
